(19) United States
(12) Patent Application Publication
(10) Pub. No.: US 2023/0139247 A1
(43) Pub. Date: May 4, 2023

(54) INFORMATION PROCESSING APPARATUS

(71) Applicant: KYOCERA Document Solutions Inc., Osaka (JP)

(72) Inventors: Shinichi KAWAGUCHI, Osaka (JP); Nobuto FUJITA, Osaka (JP)

(21) Appl. No.: 17/912,662

(22) PCT Filed: Mar. 16, 2021
(86) PCT No.: PCT/JP2021/010676

§ 371 Date: Sep. 19, 2022

(30) Foreign Application Priority Data
Mar. 24, 2020 (JP) 2020-053461

(51) Int. Cl. H04L 51/214

(52) U.S. Cl. CPC H04L 51/214

(57) ABSTRACT

An email forwarding processing unit 21 transmits an email for a destination to another email server using a communication device 11. An email transmission control unit 22 determines the destination of the email on the basis of transmission email information and causes the email forwarding processing unit 21 to transmit the email in a specific time zone in a local time of a destination region corresponding to the destination, if an email transmission request and the transmission email information of the email are received from a user. Further, the email forwarding processing unit 21 includes transmission date and time information into a header of the email, and the email transmission control unit 22 adds reception date and time information of the email transmission request into a body of the email.

### TECHNICAL FIELD

The present invention relates to an information processing apparatus.

### BACKGROUND ART

In an email storage-and-delivery system, an email server stores an email and transmits the email to a destination of the email on a specified day obtained by considering a time difference from a country including the destination (for example, see PATENT LITERATURE #1).

### CITATION LIST

### Patent Literature

PATENT LITERATURE #1: Japanese Patent Application Publication No. H10-303972.

### SUMMARY OF INVENTION

### Technical Problem

In the aforementioned system, after an email is saved in the email server, the email is transmitted from the email server, and a transmission date and time of the email from the email server can be determined by a recipient side because it is described in an email header of the email, but the recipient side hardly determines a date and time that a sender of the email actually performed a transmission operation (i.e. transmission of a transmission request to the email server) to the email server. Therefore, the recipient side hardly arranges the received emails in time series and/or hardly uses the received email as an evidence based on the transmission date and time.

The present invention has been conceived in view of the aforementioned problem, and it is an object of the present invention to obtain an information processing apparatus that enables a recipient side to determine a date and time that a sender actually performed a transmission operation to an email server even if transmission timing of the email is adjusted.

### Solution to Problem

An information processing apparatus according to the present invention includes a communication device; an email forwarding processing unit that transmits an email for a destination using the communication device; and an email transmission control unit that (a) determines the destination of the email on the basis of transmission email information and (b) causes the email forwarding processing unit to transmit the email in a specific time zone in a local time of a destination region corresponding to the destination, if an email transmission request and the transmission email information of the email are received from a user. Further, the email forwarding processing unit includes transmission date and time information into a header of the email, and the email transmission control unit adds reception date and time information of the email transmission request into a body of the email.

### Advantageous Effect of Invention

By means of the present invention, obtained is an information processing apparatus that enables a recipient side to determine a date and time that a sender actually performed a transmission operation to an email server for an email even if transmission timing of the email is adjusted.

These and other objects, features and advantages of the present invention will become more apparent upon reading of the following detailed description along with the accompanied drawings.

### BRIEF DESCRIPTION OF DRAWINGS

FIG. 1 shows a block diagram that indicates a configuration of an information processing apparatus according to an embodiment of the present invention;

FIG. 2 shows a diagram that indicates an example of an email transmitted from the information processing apparatus 1 shown in FIG. 1;

FIG. 3 shows a flow chart that explains an email transmission request receiving process in the information processing apparatus 1 shown in FIG. 1; and

FIG. 4 shows a flow chart that explains an email transmitting process in the information processing apparatus 1 shown in FIG. 1.

### DESCRIPTION OF EMBODIMENTS

Hereinafter, embodiments according to aspects of the present invention will be explained with reference to a drawing.

### Embodiment 1

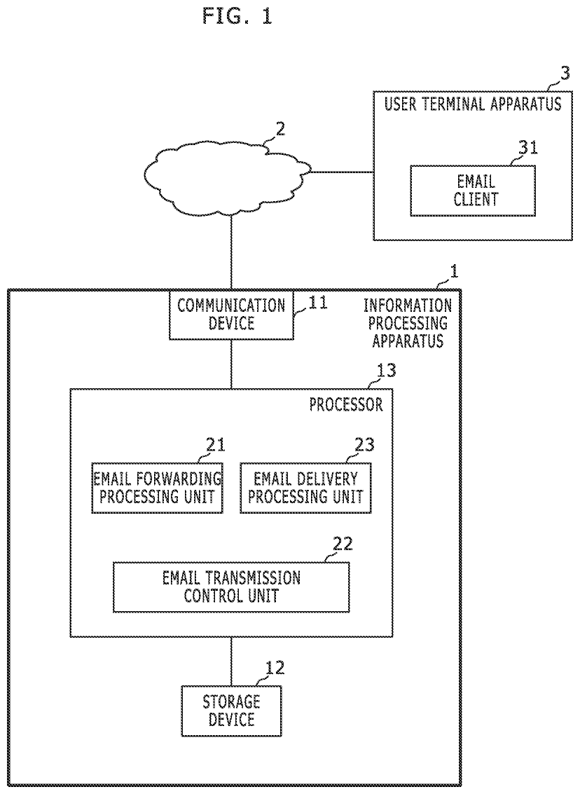

FIG. 1 shows a block diagram that indicates a configuration of an information processing apparatus according to an embodiment of the present invention. The information processing apparatus 1 shown in FIG. 1 is an email server apparatus and includes a communication device 11, a storage device 12, and a processor 13.

The communication device 11 is a network interface, for example, and is connected to a computer network 2 such as Internet, and performs data communication with another email server and an email client 31 in a user terminal apparatus 3 (a personal computer or the like) through the computer network 2 in accordance with predetermined protocols (SMTP (Simple Mail Transfer Protocol) and POPS (Post Office Protocol version 3), or the like).

The storage device 12 is a non-volatile storage device such as hard disk, flash memory or SSD (Solid State Drive), and stores a program and data for the processor 13 and the like.

The processor 13 is a computer that includes a CPU (Central Processing Unit), a ROM (Read Only Memory), a RAM (Random Access Memory) and the like, and loads a program to the RAM from the ROM or the storage device 12 and executes the program using the CPU and thereby acts as sorts of processing units.

Here, the processor 13 acts as an email forwarding processing unit 21, an email transmission control unit 22, and an email delivery processing unit 23.

The email forwarding processing unit 21 transmits an email for a destination to another email server using the communication device 11, for example, in accordance with SMTP.

The email transmission control unit 22 receives an email transmission request and transmission email information of an email through the computer network 2 from a user (i.e. an email client 31); and upon receiving the email transmission request and the transmission email information, the email transmission control unit 22 (a) determines a destination (specifically, destination email address) of the email on the basis of the transmission email information and (b) causes the email forwarding processing unit 21 to transmit the email in a specific time zone (for example, a time zone from starting to an end of business on weekdays) in a local time of a destination region corresponding to the destination. Therefore, if a current time point is included in this specific time zone, then this email is immediately transmitted; and if a current time point is not included in this specific time zone, then this email is saved until the specific time zone and is transmitted when the specific time zone comes. The specific time zone has been set in a table (not shown) or the like correspondingly to a destination (a personal email address, a domain or the like), and is determined by referring to the table or the like.

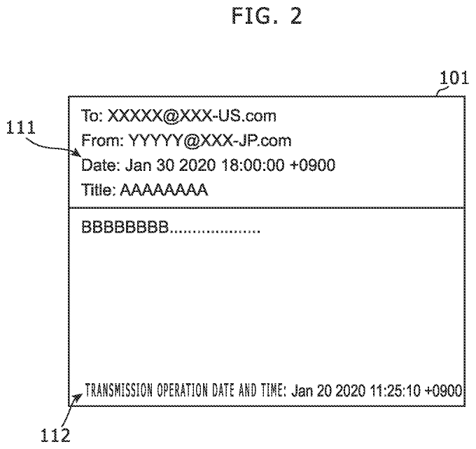

FIG. 2 shows a diagram that indicates an example of an email transmitted from the information processing apparatus 1 shown in FIG. 1. Further, as shown in FIG. 2, the email forwarding processing unit 21 includes transmission date and time information 111 into a header of an email 101 transmitted on the basis of the transmission email information, and the email transmission control unit 22 adds reception date and time information 112 of the email transmission request into a body of the email 101.

Furthermore, in Embodiment 1, if the email transmission control unit 22 received an absence notification email from the aforementioned destination, the email transmission control unit 22 (a) determines an absence period described in a body of the absence notification email using natural language processing for example, and (b) causes the email forwarding processing unit 21 to transmit the email in the aforementioned specific time zone after an end of the absence period (here, a specific time zone firstly coming after the end of the absence period).

For example, if the body of the absence notification email includes a sentence such as “I will be out from January 10th to January 20th.”, then a period from January 10th to January 20th (specifically, from 00:00 AM on January 10th to 00:00 AM on January 21st) is determined as the absence period.

The email delivery processing unit 23 receives a delivery request for a received email through the computer network 2 from a user (i.e. an email client 31) in accordance with POPS, for example, and transmits to the email client 31 a received email addressed to the user.

For example, if an automatic response setting of an absence notification email is set for a destination (email address), when an email is transmitted from a user to this destination, an absence notification email from this destination to this user is received as the received email.

It should be noted that a user who can transmit and receive an email using this information processing apparatus 1 has been registered in this information processing apparatus 1 in advance.

The following part explains a behavior of the image processing apparatus 1 of the aforementioned Embodiment 1.

### (a) Email Transmission Request Receiving Process

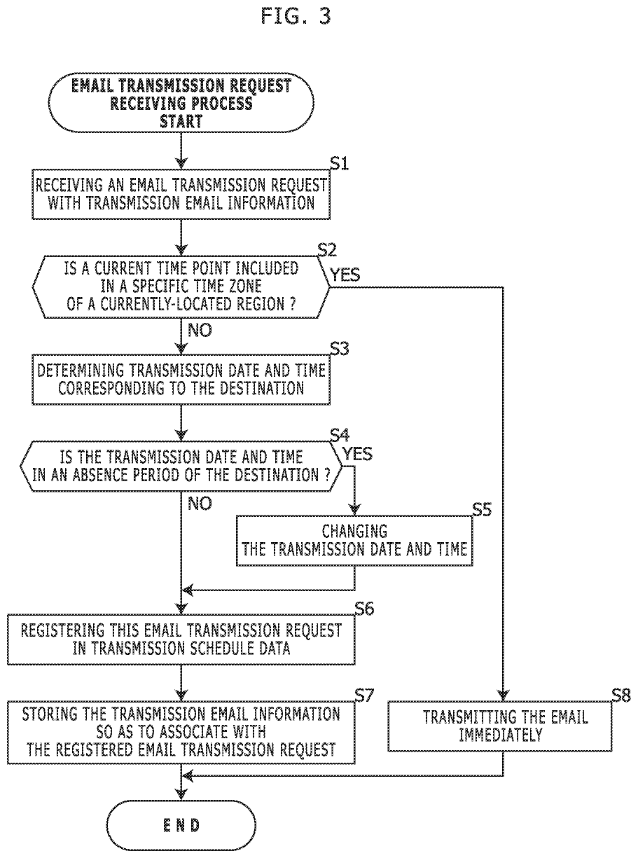

FIG. 3 shows a flow chart that explains an email transmission request receiving process in the information processing apparatus 1 shown in FIG. 1.

When the email transmission control unit 22 receives an email transmission request and transmission email information of an email through the computer network 2 from the email client 31 using the communication device 11 in accordance with SMTP, for example (in Step S1), the email transmission control unit 22 determines a destination of the email on the basis of the transmission email information, determines a specific time zone of a region that the destination is located, and determines whether a current time point is included in the specific time zone of the region that the destination is located or not (in Step S2).

If the current time point is not included in the specific time zone of the region that the destination is located, the email transmission control unit 22 determines a transmission date and time of this email corresponding to the destination (here, a specific time in the specific time zone on the earliest business day) (in Step S3).

Here, the email transmission control unit 22 determines whether the determined transmission date and time is in an absence period of the destination or not (in Step S4); and if the determined transmission date and time is in an absence period of the destination, then the email transmission control unit 22 changes the transmission date and time to the specific time zone after an end of the absence period (in Step S5).

Subsequently, the email transmission control unit 22 registers the email transmission request in transmission schedule data (in Step S6), and stores the transmission email information into the storage device 12 (in Step S7). The transmission schedule data includes the transmission date and time, the email transmission request, a specifying information (file path or the like) of the transmission email information and the like, and the transmission schedule data is stored in the storage device 12.

Contrarily, if the current time point is included in the specific time zone of the region that the destination is located, the email transmission control unit 22 immediately causes the email forwarding processing unit 21 to transmit this email (in Step S8). In this case, the email transmission control unit 22 may determine whether a current time point is in an absence period of this destination or not; and if the current time point is in an absence period of this destination, the email transmission control unit 22 may not immediately transmit this email and may register this email transmission request into the transmission schedule data with specifying a transmission date and time in the specific time zone after the end of the absence period, and may store the transmission email information into the storage device 12.

### (b) Email Transmitting Process

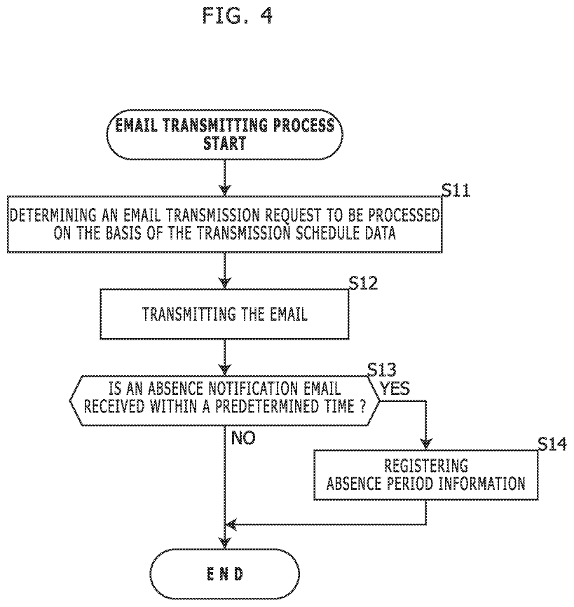

FIG. 4 shows a flow chart that explains an email transmitting process in the information processing apparatus 1 shown in FIG. 1.

The email transmission control unit 22 periodically determines the email transmission request of which the transmission data and time registered in the transmission schedule data has come (in Step S11), and reads the transmission email information corresponding to the determined email transmission request and causes the email forwarding processing unit 21 to transmit an email corresponding to this request (in Step S12). The email transmission control unit 22 deletes in the transmission schedule data the email transmission request of which email transmission is completed.

The email transmission control unit 22 watches whether an absence notification email from the destination of the email is received within predetermined time from the transmission of the email (in Step S13); and if the absence notification email is received, then the email transmission control unit 22 determines an absence period on the basis of the absence notification email and registers, for example, in an absence period table (not shown) a destination email address of the original email (i.e. a sender email address of the absence notification email), a sender email address of the original email (i.e. a destination email address of the absence notification email), and absence period information that indicates the absence period (in Step S14). The absence period table is stored in the storage device 12. It should be noted that if the email is immediately transmitted (i.e. Step S8 in FIG. 3), the same process is performed.

In Step S4 in FIG. 3 and the like, the email transmission control unit 22 determines an absence period of a destination by referring to the absence period table.

As mentioned, in Embodiment 1, the email forwarding processing unit 21 transmits an email for a destination using the communication device 11. Upon receiving an email transmission request and transmission email information of an email from a user, the email transmission control unit 22 (a) determines a destination of the email on the basis of the transmission email information and (b) causes the email forwarding processing unit 21 to transmit the email in a specific time zone in a local time of a destination region corresponding to the destination. Further, the email forwarding processing unit 21 includes transmission date and time information into a header of the email transmitted on the basis of the transmission email information, and the email transmission control unit 22 adds reception date and time information of the email transmission request into a body of the email.

Consequently, even if transmission timing of the email is adjusted, a recipient side is enabled to determine a date and time that a sender (a user) actually performed a transmission operation to an email server (i.e. the reception date and time information).

Further, if the email is transmitted after the absence period, there is a large difference between a date and time of the transmission date and time information and a date and time of the reception date and time information, and therefore the reception date and time information is more important.

### Embodiment 2

In the information processing apparatus 1 of Embodiment 2, when the email forwarding processing unit 21 is caused to transmit the email in the specific time zone after the absence period as mentioned, if the absence notification email has not been transmitted to the user, the email transmission control unit 22 notifies the user of the absence period of the destination upon receiving the email transmission request.

Specifically, the email transmission control unit 22 determines whether an absence notification email to this user has been transmitted or not on the basis of a sender email address registered in the aforementioned absence period table. If an email address of this user is included among sender email addresses registered in the absence period table correspondingly to destinations of transmitted emails, then it is determined that the absence notification email has been transmitted; and if an email address of this user is not included among sender email addresses registered in the absence period table correspondingly to destinations of transmitted emails, then it is determined that the absence notification email has not been transmitted.

For example, in order to notify the user of the absence period of the destination, the email transmission control unit 22 generates an absence notification email for this user and causes the email delivery processing unit 23 to transmit the generated absence notification email to the email client 31 of this user. At that time, a body of an absence notification email actually received from the destination may be saved, and the absence notification email to be transmitted here may be generated using the saved body.

Other parts of the configuration and behaviors of information processing apparatus 1 in Embodiment 2 are identical or similar to those in Embodiment 1, and therefore not explained here.

### Embodiment 3

In the information processing apparatus 1 of Embodiment 3, if plural destinations are specified in the aforementioned transmission email information, then the email transmission control unit 22 individually performs the aforementioned process for each of the plural destinations.

Further, if plural destinations are specified in the aforementioned transmission email information, the email transmission control unit 22 can cause the email forwarding processing unit 21 to transmit the email to the plural destinations in a predetermined order (for example, a describing order of the destination email addresses). In such a case, for each destination of the plural destinations, the email transmission control unit 22 causes the email forwarding processing unit 21 to transmit the email in the specific time zone after completing the transmission of the email to all antecedent destinations in the aforementioned order. Thus, in this order, the plural destinations can be caused to receive the email in turn.

Therefore, if the specific time zones of the plural destinations are different from each other, values of the aforementioned transmission date and time information in the emails to the plural destinations are different from each other. Contrarily, values of the aforementioned reception date and time information in the emails to the plural destinations are identical to each other.

If an absence notification email was received from any destination among the plural destinations and an end of an absence period determined from the absence notification email is later than an end of the specific time zone of this destination, the email transmission control unit 22 may select a first transmission mode; and in the first transmission mode, the email transmission control unit 22 keeps the predetermined order and causes the email forwarding processing unit 21 to transmit the email to this destination in the specific time zone after the end of the absence period determined from the absence notification email.

Otherwise, if an absence notification email was received from any destination among the plural destinations and an end of an absence period determined from the absence notification email is later than an end of the specific time zone of this destination, the email transmission control unit 22 may select a second transmission mode; and in the second transmission mode, the email transmission control unit 22 does not keep the predetermined order and excludes this destination from the predetermined order. In the second transmission mode, the email to this destination may be immediately transmitted individually (regardless of the predetermined order) or may be transmitted in the specific time zone of this destination after the absence period.

Further, if an absence notification email was received from any destination among the plural destinations and an end of an absence period determined from the absence notification email is later than an end of the specific time zone of this destination, the email transmission control unit 22 may select a transmission mode specified by a user as a sender of the email (i.e. by a user setting, a user operation or the like) among the first transmission, the second transmission mode and the like.

Other parts of the configuration and behaviors of information processing apparatus 1 in Embodiment 3 are identical or similar to those in another embodiment, and therefore not explained here.

### Embodiment 4

In the information processing apparatus 1 of Embodiment 4, if the email transmission control unit 22 determines that the aforementioned email is specified as an emergency email, then the email transmission control unit 22 immediately causes the email forwarding processing unit 21 to transmit the email even if a current time point is not in the aforementioned specific time zone.

For example, if an email body, a header or the like in the transmission email information includes a flag that indicates emergency or if an email title in the transmission email information includes a word and/or a phrase that indicate(s) emergency, then the email transmission control unit 22 determines that the email is specified as an emergency email.

Other parts of the configuration and behaviors of information processing apparatus 1 in Embodiment 4 are identical or similar to those in another embodiment, and therefore not explained here.

Further, it should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in Embodiments 1 to 4, the absence notification information may be deleted in the table when the absence period of the absence notification information is finished.

Further, in Embodiments 1 to 4, the specific time zone of a destination may be set correspondingly to an official time zone (i.e. time difference from the standard time) of a region that the destination is located. In such a case, the official time zone of the destination may be determined on the basis of time zone information described with a transmission date and time in a header of an email received from this destination.

### INDUSTRIAL APPLICABILITY

For example, the present invention is applicable to a transmission email server.

1. An information processing apparatus, comprising:
a communication device;
an email forwarding processing unit that transmits an email for a destination using the communication device; and an email transmission control unit that (a) determines the destination of the email on the basis of transmission email information and (b) causes the email forwarding processing unit to transmit the email in a specific time zone in a local time of a destination region corresponding to the destination, if an email transmission request and the transmission email information of the email are received from a user;
wherein the email forwarding processing unit includes transmission date and time information into a header of the email, and
the email transmission control unit adds reception date and time information of the email transmission request into a body of the email.

2. The information processing apparatus according to claim 1, wherein if the email transmission control unit received an absence notification email from the destination, the email transmission control unit causes the email forwarding processing unit to transmit the email in the specific time zone after an end of an absence period determined from the absence notification email.

3. The information processing apparatus according to claim 2, wherein when the email forwarding processing unit is caused to transmit the email in the specific time zone after the absence period, if the absence notification email has not been transmitted to the user, the email transmission control unit notifies the user of the absence period of the destination upon receiving the email transmission request.

4. The information processing apparatus according to claim 1, wherein if plural destinations are specified in the transmission email information and the email transmission control unit causes the email forwarding processing unit to transmits the email to the plural destinations in a predetermined order, the email transmission control unit causes the email forwarding processing unit to transmit the email to each of the plural destinations in the specific time zone after completing the transmission of the email to all antecedent destinations in the specific order;
different values of the transmission date and time information are added into the email to the plural destinations, respectively; and
values of the reception date and time information in the email to the plural destinations are identical to each other.

5. The information processing apparatus according to claim 4, wherein if an absence notification email was received from any destination among the plural destinations and an end of an absence period determined from the absence notification email is later than an end of the specific time zone of this destination, the email transmission control unit keeps the predetermined order and causes the email forwarding processing unit to transmit the email to this destination in the specific time zone after the end of the absence period determined from the absence notification email.

6. The information processing apparatus according to claim 4, wherein if an absence notification email was received from any destination among the plural destinations and an end of an absence period determined from the absence notification email is later than an end of the specific time zone of this destination, the email transmission control unit does not keep the predetermined order and excludes this destination from the predetermined order.

7. The information processing apparatus according to claim 4, wherein if an absence notification email was received from any destination among the plural destinations and an end of an absence period determined from the absence notification email is later than an end of the specific time zone of this destination, the email transmission control unit selects one of transmission modes specified by the user;
the transmission modes include a first transmission mode and a second transmission mode;
in the first transmission mode, the email transmission control unit keeps the predetermined order and causes the email forwarding processing unit to transmit the email to this destination in the specific time zone after the end of the absence period determined from the absence notification email; and
in the second transmission mode, the email transmission control unit does not keep the predetermined order and excludes this destination from the predetermined order.

8. The information processing apparatus according to claim 1, wherein if the email is specified as an emergency email, the email transmission control unit immediately causes the email forwarding processing unit to transmit the email even if a current time point is not in the specific time zone.
